(19) United States
(12) Patent Application Publication
(10) Pub. No.: US 2009/0278096 A1
(43) Pub. Date: Nov. 12, 2009

(54) A METHOD OF TREATING AN ELECTRICALLY INSULATING OIL

(75) Inventors: Karin Gustafsson, Solluntuna (SE); Robert Leandersson, Vasteras (SE)

Correspondence Address: VENABLE LLP, P.O. BOX 34385, WASHINGTON, DC, 20043-9998, US

(73) Assignee: ABS Research Ltd., Zurich (CH)

(21) Appl. No.: 12/307,771

(22) PCT Filed: Jul. 9, 2007
(86) PCT No.: PCT/EP07/56975

§ 371 Date: Jan. 7, 2009

(30) Foreign Application Priority Data
Jul. 7, 2006 (EP) 06116794.6

(51) Int. Cl. H01B 3/20; H01B 3/24; B01J 19/00; G01N 21/00

(52) U.S. Cl. 252/574; 252/570; 422/129; 422/69

(57) ABSTRACT

A method of treating an electrically insulating oil, wherein the oil includes at least one reactive organic sulphur compound. A chemical agent causing a reaction with the reactive organic sulphur compound is added to the oil. The chemical agent includes an elementary halogen or a halogen compound.

### TECHNICAL AREA

The present invention relates to a method of treating an electrically insulating oil, wherein the oil comprises at least one reactive organic sulphur compound.

### TECHNICAL BACKGROUND

Insulating oils are used in a number of different apparatus in the field of electrical power transmission and electrical power generation, for example; power transformers, distribution transformers, tap changers, switchgear and reactors.

These electrically insulating oils often contain traces of reactive organic sulphur compounds, for example organic disulphides or thiols (also known as mercaptans), and these reactive sulphur compounds may react with copper or copper oxide, forming copper sulphide (Cu₂S).

One possible reaction path is by copper reacting with thiols forming copper mercaptides. The copper mercaptides can decompose further, leading to the formation of copper (I) sulphide, Cu₂S.

Cu₂O+2RSH=>2CuSR+H₂O

2CuSR=>Cu₂S+RSR

where RSH is a thiol, —SH is a thiol group (or mercaptan), —R is an alkyl group and RSR is a thioether.

Other sulfurorganics, especially disulphides, can also be active, either by direct reaction with copper or via conversion to thiols.

Copper sulphide (Cu₂S) is insoluble in oil and may form deposits, especially on surfaces of cellulose material (i.e. a form of paper) used to cover the copper conductors immersed in said electrically insulating oil. The copper sulphide is a semiconductor and the formation of a semiconducting deposit on the paper might lead to a degrading of the insulation properties of the paper-oil system which could lead to short circuits. These short circuits can be avoided by removing the organic disulphides from the oil and thereby preventing the formation of copper sulphide (Cu₂S).

### PRIOR ART

CIGRE Moscow symposium 2005 “Oil corrosion and Cu₂S deposition in Power Transformers”; Bengtsson et al. describes the results of failure analysis and a laboratory reproduction of the copper sulphide Cu₂S deposits on surfaces and materials in power transformers.

WO2005115082 entitled “Method for removing reactive sulfur from insulating oil” describes a method for removing sulphur-containing compounds from insulating oil by exposing the oil to at least one sulphur scavenging material and exposing the oil to at least one polar sorbent.

The described method in WO2005115082 requires the oil to be pre-treated and the method requires large amounts of sulphur scavenging material such as zinc. All the equipment needed to perform the method is similar in size to a large transformer. The process is complex, time consuming and the columns with scavenger and sorbent have to be regenerated after some processing time.

JP2001311083 describes how sulphur compounds in electrically insulation oils can be removed before the use in an electrical apparatus by storing the oil in a vessel containing copper or copper alloys. The sulphur compounds in the oil react with the copper and are thus captured and removed from the oil prior to the use in the electrical apparatus.

### SUMMARY OF THE INVENTION

One embodiment of the present invention is to provide a method and apparatus by means of which an electrically insulating oil used as insulation in an electrical apparatus may be treated in order to remove reactive organic sulphur compounds and thereby prevent the formation of copper sulphide therein.

One embodiment of the invention is achieved by means of the initially defined method, characterized in that a chemical agent causing a reaction of said reactive organic sulphur compound is added to the oil. The chemical agent will induce a reaction by which the reactive organic sulphur compound is transformed into more volatile reaction products which then can be removed from the oil.

Preferably, said chemical agent comprises a halogen or a halogen compound, and according to a preferred embodiment said halogen comprises iodine (I₂) or chlorine (Cl₂) in elementary form and the halogen compound comprises hydrogen iodide (HI).

According to an embodiment the amount of said chemical agent added to the oil is at least equal to the amount needed for a complete reaction of said reactive organic sulphur compound into one or more reaction products.

According to an embodiment the concentration of said chemical agent in the electrically insulating oil is measured before and/or after the reaction with said reactive organic sulphur compounds and the measuring of chemical agent concentration is done by spectroscopic absorption measurement. The addition of chemical agent to the oil is controlled by said measurements.

According to an embodiment the concentration of reactive organic sulphur compounds in the electrically insulating oil is measured before and/or after the addition of said chemical agent.

Preferably the amount of said chemical agent added to the oil is the equivalent amount needed for a complete reaction of said reactive organic sulphur compounds into one or more reaction products however the exact amount of reactive organic sulphur compounds might not be exactly known but can be estimated. From this estimation the amount of chemical agent for controlling the process could be expressed as for example (g chemical agent)/(kg oil) and then the method controls the addition of chemical agent in a batch process by only adding as much chemical agent as is estimated to be necessary in the oil. In a continuous process the amount of chemical agent added to oil may be controlled dependent on the flow rate of the electrically insulating oil.

According to an embodiment of the invention a method is provided that further comprising the step of adding said chemical agent and the subsequent reaction is performed in an atmosphere with lower oxygen partial pressure than in air and this lower oxygen partial pressure can be achieved by replacing the air in the system with inert gas, for example nitrogen or by lowering the total pressure in the system or performing the reaction in reduced pressure atmosphere or vacuum.

According to an embodiment of the invention, a method comprises the step of tempering the electrically insulating oil before the addition of said chemical agent. The speed of the reaction of the chemical agent with the reactive organic sulphur compounds increases with temperature but the temperature should not be so high that the oil is affected negatively. A possible temperature range for the reaction in oil is 60-120 degrees Celsius and the preferable temperature range for the reaction in oil is 80-100 degrees Celsius.

According to an embodiment of the invention a method is provided that further comprising the step subsequent of adding said chemical agent, and after a subsequent reaction due to said addition, in which said reactive organic sulphur compounds are transformed into one or more reaction products, said one or more reaction products are removed from the electrically insulating oil.

According to an embodiment of the invention a method is provided that further comprising the step of carrying out the removal of said one or more reaction products from the electrically insulating oil by means of in part reduced pressure atmosphere or vacuum.

According to an embodiment of the invention a method is provided that further comprising the step of carrying out the removal of said one or more reaction products from the electrically insulating oil by means of injecting an inert gas such as nitrogen in the oil.

According to an embodiment of the invention the optical properties of the treated electrically insulating oil is compared with untreated oil. The electrically insulating oil can be affected by too much chemical agent or that the reaction occurs at too high temperatures and by comparing, for example, the color and/or transparency of the treated oil with the untreated oil it is possible to control the process or give an operator a warning signal.

According to an embodiment of the invention, dissolved iodine has an absorption at wavelengths that are easily distinguished from the background absorption of electrically insulation or transformer oils. The spectroscopic measurements can therefore be used for on-line control of the amount of added chemical agent.

According to an embodiment of the invention a method is provided that further comprise the step of adding an oxidation inhibitor to the electrically insulating oil subsequent to the removal of said one or more reaction products.

According to an embodiment of the invention a method is provided that further comprise the step of adding a metal passivator, adapted to prevent a formation of copper sulphide in the electrically insulating oil subsequent to the removal of said one or more reaction products.

According to an embodiment of the invention a method is provided that further comprise the step of the electrically insulating oil is comprised in an electric transformer, and that oil to be treated by means of said chemical agent is extracted from said transformer.

According to an embodiment of the invention a method is provided that further comprise the step of continuously extracting electrically insulating oil to be treated from a transformer in which the oil is located and feeding said oil through a treatment circuit and back into the transformer

According to an embodiment of the invention a method is provided that further comprise the step of carrying out in said treatment circuit at least one of the steps of; measuring the content of reactive organic sulphur compound in the oil, tempering the oil, adding said chemical agent thereto, removing formed reaction products therefrom, adding an oxidation inhibitor, adding a metal passivator.

The method according to the present invention is normally suitably used at reactive organic sulphur compound concentrations higher than 5 ppm. In some used electrically insulating oils, the concentration may be as high as several hundred ppm.

According to an embodiment of the invention, an apparatus for treating an electrically insulating oil, wherein the oil comprises at least one reactive organic sulphur compound, comprising at least one vessel, and an amount of a chemical agent, and said chemical agent comprises an elementary halogen or halogen compound and said apparatus also comprises at least one vessel adapted with means to introduce one or more amounts of the chemical agent into said electrically insulating oil.

According to an embodiment of the invention, a system for treating an electrically insulating oil, wherein the oil comprises at least one reactive organic sulphur compound, comprising; an electrical apparatus containing said electrically insulating oil, an oil treatment apparatus and means for moving the oil from said electrical apparatus to said oil treatment apparatus and said oil treatment apparatus comprises means for removing at least one reactive organic sulphur compound from the electrically insulating oil with a chemical agent comprising an elementary halogen or halogen compound.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates a schematic process diagram of the method.

FIG. 2 is a flowchart of one embodiment of the invention.

FIG. 3 is a flowchart of another embodiment of the invention.

FIG. 4 is a flowchart of another embodiment of the invention.

FIG. 5 shows an embodiment of the present invention on how the chemical agent could be added to the oil.

FIG. 6 shows another embodiment of how the chemical agent could be added to the oil.

FIG. 7 shows a process diagram of an embodiment of the present invention.

FIG. 8 shows schematically a mobile processing plant 70 for treating oil from an electrical apparatus.

FIG. 9 shows another embodiment of the present invention on how the chemical agent (iodine) could be added to the oil.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

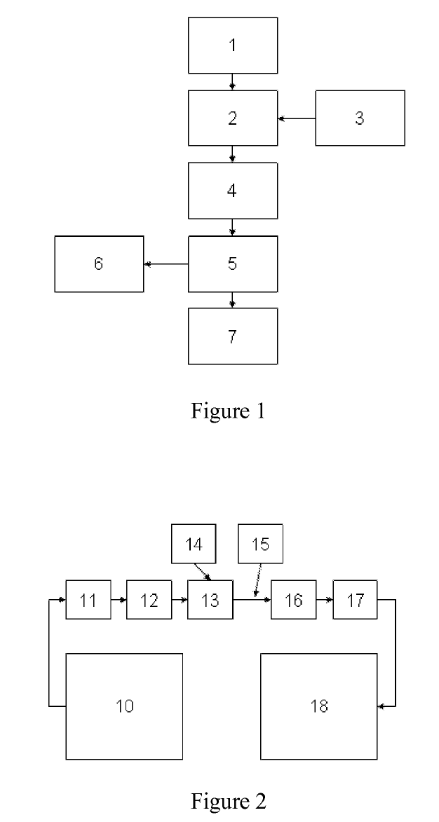

FIG. 1 shows a schematic process diagram of the method. In block 1 the electrically insulating oil is tempered to the correct temperature for the reaction to proceed. In block 2 the chemical agent (from the chemical agent source in block 3) is added to the oil together with an inert gas and starts to react with the reactive organic sulphur compound present in the oil. The inert gas is added to the oil to assist the reaction between the chemical agent and the reactive organic sulphur compound, by allowing volatile reaction products to leave the oil phase during reaction.

In block 4 the reactive organic sulphur compound (e.g. an organic disulphide with the general chemical formula; R1-S—S—R2, where R1 and R2 are general organic substituents) has reacted with the chemical agent and formed reaction products.

In block 5 the electrically insulating oil containing the volatile reaction products is exposed to a low pressure atmosphere or vacuum and the volatile reaction products as well as un-reacted chemical agent and dissolved inert gas are removed from the oil.

In block 7 the treated electrically insulating oil may undergo some final processing steps (for example, filtering, adding oxidizing inhibitor, adding metal passivator, tempering).

FIG. 2 illustrates a flowchart of one embodiment of the invention. In this flowchart the oil taken from one tank 10, continuously is treated and stored in a second tank 18. The electrically insulating oil, contaminated with high levels of reactive organic sulphur compounds, is stored in a tank 10. This tank could be a storage tank for contaminated oil or an electrical apparatus such as a power transformer, a distribution transformer, a tap changer, switchgear or a reactor. A pump 11 pumps the oil from the tank 10 to a heater 12 which brings the oil up to the required reaction temperature.

From a chemical agent reservoir 14 the chemical agent is mixed with the electrically insulating oil in a mixer 13 and a reaction between the reactive organic sulphur compounds and the agent occurs. The chemical agent can be mixed with inert gas (e.g. nitrogen) to assist the reaction. The oil with reaction products are then moved to a degassing unit 16 where the oil with the volatile reaction products is exposed to a low pressure atmosphere or vacuum and the volatile reaction products as well as un-reacted chemical agent and dissolved inert gas are removed from the oil. There is a possibility to add additional inert gas (e.g. nitrogen) from an inert gas source 15 to the oil during the reaction or before the degassing to assist the removal of the reaction products.

After the degassing the oil usually have to go through one or more post processing steps 17 such as filtering, adding inhibitors or stabilizers and then the oil is stored in a tank 18 for treated oil.

Preferably the amount of said chemical agent added to the oil is at least the equivalent amount needed for a complete transition of said reactive organic sulphur compounds into one or more reaction products. In this embodiment of the invention one single measurement of the amount of reactive organic sulphur compounds in the contaminated oil is needed since the concentration of reactive organic sulphur compounds in the untreated oil is constant during the whole process. The amount of chemical agent that needs to be added in the mixer 13 is constant or if the flow rate of the oil varies the amount of chemical agent is proportional to the oil flow rate.

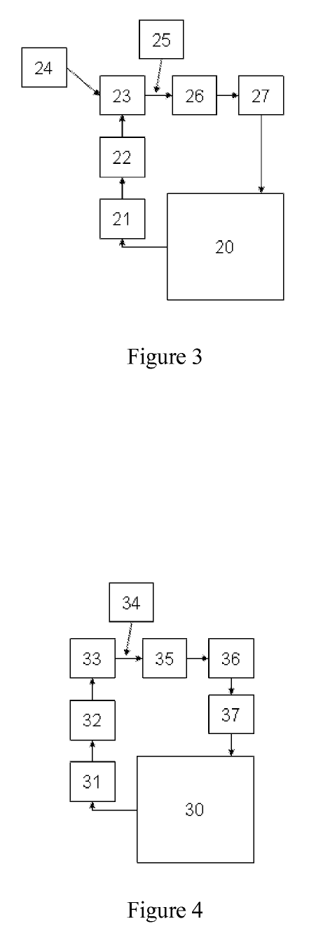

FIG. 3 illustrates a flowchart of another embodiment of the invention. In this flowchart the oil taken from one tank, continuously is treated and fed back into the same tank. The electrically insulating oil, contaminated with high levels of reactive organic sulphur compounds, is stored in a tank 20. This tank could be a storage tank for contaminated oil or an electrical apparatus such as a power transformer, a distribution transformer, a tap changer, switchgear or a reactor. A pump 21 pumps the oil from the tank 20 to a heater 22 which brings the oil up to the required reaction temperature.

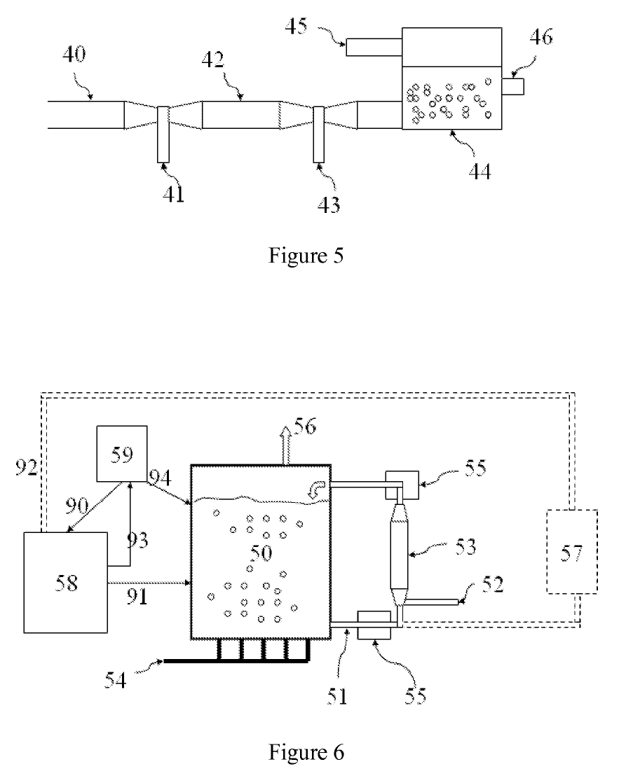

From a chemical agent reservoir 24 the reaction agent is mixed with the electrically insulating oil in a mixer 23. The chemical agent could be in gas phase and injected into the oil in an apparatus as shown in FIG. 5. The chemical agent could furthermore be mixed with inert gas (e.g. nitrogen) before it is mixed in oil. After mixing, a reaction between the reactive organic sulphur compounds and the agent occurs. The oil with reaction products are then moved to a degassing unit 26 where the oil with the volatile reaction products is exposed to a low pressure atmosphere or vacuum and the volatile reaction products as well as un-reacted chemical agent are removed from the oil. There is a possibility to add an inert gas (e.g. nitrogen) from an inert gas source 25 to the oil before or at the degassing to assist the removal of the reaction products.

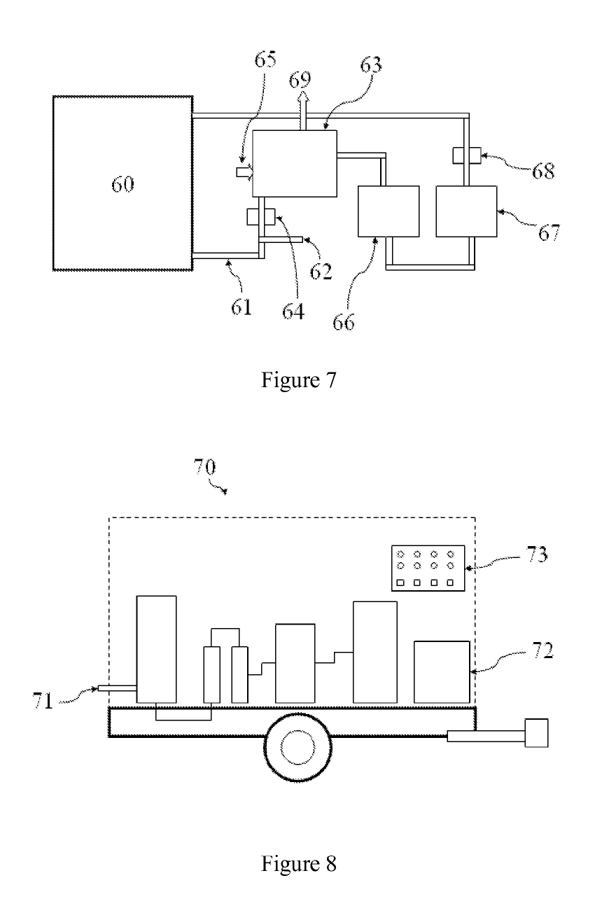

After the degassing the oil usually have to go through one or more post processing steps 27 such as filtering, adding inhibitors or stabilizers and then the oil fed back to the same tank 20 where it was taken form. By spectroscopic absorption measurement, the amount of chemical agent remaining in the treated oil could be monitored. An apparatus as shown in FIG. 7 or similar could be used to realize this process flowchart.

In this embodiment of the invention the amount of reactive organic sulphur compounds in the contaminated oil is constantly changing. The change in reactive organic sulphur compound concentration will most likely follow some kind of exponential decay function, so with a few measurements or with one measurement and lots of experience the concentration of reactive organic sulphur compounds in the oil at any time during the process can be estimated. With this estimation of reactive organic sulphur compound concentration the amount of chemical agent that need to be added in the mixer 23 can be determined.

FIG. 4 illustrates a flowchart of another embodiment of the invention. In this flowchart the oil taken from one tank, is continuously treated and fed back into the same tank. The electrically insulating oil, contaminated with high levels of reactive organic sulphur compounds, is stored in a tank 30. This tank could be a storage tank for contaminated oil or an electrical apparatus such as a power transformer, a distribution transformer, a tap changer, switchgear or a reactor. A pump 31 pumps the oil from the tank 30 to a heater 32 which brings the oil up to the required reaction temperature.

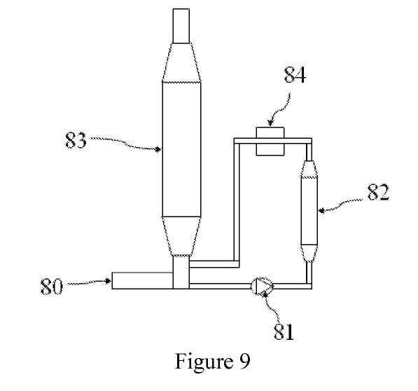

The oil passes through a column 33 where the chemical agent is located. The chemical agent can be solid crystals or granulate where, for example, the flow makes a fluidized bed or the chemical agent could be fixed to a matrix which the oil passes through. The column 33 can be of the type shown in FIG. 9 where part of the flow passes the column with chemical agent and another part of the flow bypasses the chemical agent column and the two oil streams are then mixed to achieve the right chemical agent concentration in oil. Furthermore, an inert gas could be added to the oil and chemical agent to assist the reaction (by allowing volatile reaction products to leave the oil phase during reaction) and increase turbulence.

The column 33 can be a mixing column where gaseous chemical agent (iodine or hydrogen iodide, possibly with inert gas) is mixed with the oil.

Iodine could also be mixed into oil as a stock solution of iodine in oil. Hydrogen iodide could be added to the oil in a concentrated aqueous solution (i.e. HI dissolved in water). The water in aqueous solution added to the oil will then have to be removed e.g. by treatment of the oil in a degasser or dryer.

The oil with reaction products are then moved to a degassing unit 35 where the oil with the volatile reaction products is exposed to a low pressure atmosphere or vacuum and the volatile reaction products as well as un-reacted chemical agent and dissolved inert gas are removed from the oil. There is a possibility to add additional inert gas (e.g. nitrogen) from an inert gas source 34 to the oil during reaction or before or at the degassing to assist the removal of the reaction products.

After the degassing the oil usually have to go through one or more post processing steps 36 such as filtering, adding inhibitors or stabilizers and then the oil fed back to the same tank 30 where it was taken form.

FIG. 5 shows an embodiment of the present invention on how the chemical agent could be added to the oil. The oil is drawn from an electrical apparatus or from a storage tank for insulation oil 40. The chemical agent (comprising elementary iodine or hydrogen iodide, in gas phase) is injected 41 into the oil stream. The chemical agent could be mixed with an inert gas before injection to reduce the partial pressure of the chemical agent, to increase the turbulence and mixing of chemical agent/oil mix and to assist the reaction by removing volatile reaction products from the oil phase. The oil with reactive organic sulphur components are mixed with the chemical agent (and inert gas) in a mixing chamber 42. When they are mixed, it is possible to add additional inert gas to the oil stream 43. The oil and chemical agent react in the reaction chamber 44. In the reaction chamber 44, part of the inert gas and un-reacted chemical agent in the oil is removed 45 and additional inert gas could be added in the reaction chamber 44. Different parts of the apparatus could be under different pressures. Reacted oil is removed 46 and transferred to further processing steps (such as degassing). The reaction chamber 44 is temperature controlled and could be bigger than indicated by the FIG. 5. Suitable retention time for oil in the reaction chamber 44 should be between a few minutes to a few hours, depending on the reaction temperature, chemical agent concentration and pressure.

The concentration of chemical agent (specifically iodine) in the electrically insulating oil can be measured by spectroscopic measurements. Dissolved iodine has an absorption at wavelengths that are easily distinguished from the background absorption of electrical insulation or transformer oils. The spectroscopic measurements can therefore be used for on-line control of the amount of added chemical agent or the ratio between chemical agent and inert gas added in 41. One embodiment of the present invention is to measure the absorption in the reaction volume 42. One embodiment of the present invention is to measure the absorption in the oil leaving 46 the degassing chamber 44 to ensure that concentration of chemical agent is sufficiently low.

The chemical agent injected 41 into the oil stream do not have to be in gas phase, it may also be iodine stock solution (oil based) or hydrogen iodide as a concentrated aqueous solution.

FIG. 6 shows another embodiment of the present invention on how the oil in an electrical apparatus 58 could be processed by chemical agent. Part of the oil (or all the oil) in an electrical apparatus 58 is put into a reaction chamber or reaction tank 50. From the tank 50, the oil is drawn 51 out of the tank 50 and chemical agent 52 (iodine or hydrogen iodide, possibly mixed with inert gas) is injected into the oil stream. The oil and chemical agent are mixed in a mixing chamber 53. The tank 50 and the mixing chamber 53 are temperature controlled. The oil with dissolved chemical agent is fed back into the tank 50. The concentration of chemical agent (specifically iodine) in the electrically insulation oil can be measured by spectroscopic measurements 55, before and/or after the addition of chemical agent. These measurements control the rate of addition of chemical agent to the oil. Dissolved iodine has an absorption at wavelengths that are easily distinguished from the background absorption of electrically insulation or transformer oils. The spectroscopic measurements 55 can therefore be used for on-line control of the amount of added chemical agent or the ratio between chemical agent and inert gas added in 52. One embodiment of the present invention is to measure the absorption of the oil before it is fed back into the tank 50. Another embodiment of the present invention is to measure the absorption of the oil before the chemical agent is added 52 to the oil. The volatile reaction products generated by the reaction between the chemical agent and reactive organic sulphur compounds in the tank can be removed 56 from the storage tank. Additional inert gas 54 could be added in the reaction tank to assist the reaction and to remove the volatile reaction products.

The process performed by the apparatus in FIG. 6 is a batch procedure. Possible steps in a procedure for treating the oil in an electrical apparatus;
1. add 90 a volume of new oil (in a holding tank 59) into the apparatus 58 and at the same time,
2. remove 91 the same volume of oil from the apparatus 58
3. treat the oil in the tank 50 for some time (hours to a few days) or until it fulfills some requirement
4. optional step; hold the oil in the tank 50 for some time with a reduced pressure atmosphere and continue to feed inert gas 54 into the oil, i.e. a pre-degassing step
5. remove 51 the oil from the tank 50 and use a degasser 57 and possibly further cleaning steps to remove the final impurities in the oil, and feed the oil back 92 into the apparatus 58 and at the same time
6. remove 93 the same volume of oil from the apparatus 58 into the holding tank 59
7. when the tank 50 is empty of oil, fill 94 the tank 50 with oil from the holding tank 59
8. return to step 3 until the oil in the apparatus 58 fulfills some requirement

With this procedure the electrical apparatus can be online for the whole time and the apparatus 58 is always full with oil.

FIG. 7 shows a process diagram of an embodiment of the present invention. The oil is continuously drawn 61 e.g. by a pump, from the electrical apparatus 60. Chemical agent (iodine or hydrogen iodide) is added 62 to the oil and the added chemical agent reacts with reactive organic sulphur compounds in a reaction chamber 63. The concentration of chemical agent in oil is spectroscopic measured 64 before the oil enters the reaction chamber 63. Inert gas 65 is injected into the oil in the reaction chamber 63 to assist the reaction and volatile reaction products and inert gas is removed 69 from the reaction chamber 63. After the oil has been processed in the reaction chamber 63, it continues to a degasser 66. A second degasser 67 with lower pressure could be needed to remove all gasses, chemical agent and reaction products. The pressure in the first degasser 66 could be between 250 mBar to 10 mBar and the pressure in the second degasser 67 could be between 10 mBar to 0.01 mBar. To control that sufficient chemical agent have been removed from the oil, a spectroscopic measurement 68 of the chemical agent content in oil can be performed before the oil is fed back in the electrical apparatus 60.

If the concentration of chemical agent is too high in spectroscopic measurement 68, the feeding back of oil into the electrical apparatus 60 is stopped. To bring the concentration of chemical agent down in the treated oil, the output of the second degasser 67 could be fed into the first degasser 66 until the spectroscopic measurement 68 indicates that sufficient chemical agent have been removed from the oil.

The process described in FIG. 7 is continuous. The process takes oil directly from the apparatus, process the oil and feeds the processed oil directly back into the apparatus.

FIG. 8 shows a schematic drawing of a mobile processing plant 70 for treating oil from an electrical apparatus arranged on a mobile platform. The plant comprises connections 71 for introducing the oil into the plant from the apparatus as well as connections for expelling treated oil. The mobile plant further comprises reaction chambers, piping, means for injecting chemical agent and inert gas, means for degassing the oil, means for filtering oil, as well as storage for chemical agent(s) and inert gas. The plant can be a batch processing plant (e.g. as described in FIG. 6) or a continuous processing plant (e.g. as described in FIG. 7). The mobile plant also comprises electrical energy generating means 72 which could be a combustion motor with generator for powering the mobile plant and means for connecting the mobile plant to the electrical grid. The mobile plant also comprises control means 73 for controlling the process. The mobile platform could be arranged on a trailer or the plant could be arranged on a truck.

FIG. 9 shows another embodiment of the present invention on how the chemical agent (iodine) could be added to the oil. The oil is drawn 80 from a tank or an electrical apparatus. Part of the oil stream is diverted by pumping means 81. The diverted oil passes through solid iodine crystals, in a fluidized bed 82 or a packed column 82. The oil is saturated or partly saturated with iodine and the diverted oil stream is then mixed with the rest of the oil stream in proportions to make the required iodine concentration in all the oil. The concentration of iodine in oil can be spectroscopically measured 84 before and/or after the oil is mixed with the oil without iodine. The reactive organic sulphur compounds can then mix and react with iodine in a reaction chamber 83. Inert gas is also added to the oil to assist the reaction in the reaction chamber 83

An alternative method for dosing iodine to the oil is to pass an inert gas through the iodine crystals in e.g. a column. The resulting mix of iodine vapor and inert gas is then mixed with oil. The column might be heated to increase the amount of evaporated iodine.

Iodine can also be added into the oil as oil based stock solution with known concentration.

The chemical agent hydrogen iodide can be generated directly when it is needed to be injected in gas phase into the electrically insulating oil.

There are several ways to produce hydrogen iodide directly. By the reaction of iodine with hydrazine (N₂H₄) which produces hydrogen iodide and nitrogen or by hydrolysis of phosphorus triiodide (PI₃) or by irradiating a mix of hydrogen and iodine gas with the wavelength of light equal to the dissociation energy of iodine (I₂), about 578 nm.

The chemical agent hydrogen iodide can also be added into the oil as a concentrated aqueous solution, and then hydrogen iodide does not have to be generated directly where it is needed.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method of treating an electrically insulating oil, wherein the oil comprises at least one reactive organic sulphur compound, the method comprising:
adding to the oil a chemical agent causing a reaction with said reactive organic sulphur compound, said chemical agent comprising an elementary halogen or a halogen compound.

2. A method according to claim 1, wherein at least one said elementary halogen is iodine (I₂).

3. A method according to claim 1, wherein at least one said elementary halogen is chlorine (Cl₂).

4. The A method according to claim 1, wherein at least one said halogen compound is hydrogen iodide (HI).

5. The method according to claim 1, wherein a concentration of reactive organic sulphur compound is reduced to less than 5 ppm when the reaction is finished.

6. The method according to claim 1, further comprising:
measuring a concentration of said chemical agent in the electrically insulating oil before and/or after the reaction with said reactive organic sulphur compounds.

7. The method according to claim 6, wherein the measuring of chemical agent concentration is done by spectroscopic adsorption measurement.

8. The method according to claim 6, wherein the addition of chemical agent to the oil is controlled by said measurements.

9. The method according to claim 1, wherein said chemical agent is added in gas form to the oil.

10. The method according to claim 1, wherein said chemical agent is added by dissolving solid chemical agent in the oil.

11. The method according to claim 1, further comprising:
controlling a temperature of the oil during reaction with chemical agent.

12. The method according to claim 1, wherein a temperature of the oil during reaction is in the range of 60-120 C. degrees.

13. The method according to claim 1, wherein a temperature of the oil during reaction is in the range of 80-100 C. degrees.

14. The method according to claim 1, further comprising:
removing reaction products from the reaction between said chemical agent and said reactive organic sulphur compounds from the oil by degassing in reduced atmosphere.

15. The method according to claim 14, further comprising:
adding inert gas to the oil before degassing to assist the removal of said reaction products.

16. The method according to claim 1, wherein degassing of oil is performed in two or more steps.

17. The method according to claim 14, further comprising
adding an oxidation inhibitor to the electrically insulating oil subsequent to the removal of said one or more reaction products.

18. The method according to claim 14, further comprising:
adding an metal passivator, adapted to prevent a formation of copper sulphide in the electrically insulating oil subsequent to the removal of said one or more reaction products.

19. The method according to claim 1, wherein the electrically insulating oil is comprised in an electric transformer, the method further comprising:
extracting the oil to be treated by said chemical agent is extracted from said transformer.

20. The method according claim 19, further comprising.
continuously extracting electrically insulating oil to be treated from a transformer in which the oil is located, and
feeding said oil through a treatment circuit and back into the transformer.

21. The method according to claim 1, further comprising:
carrying out in said treatment circuit at least one of measuring a content of reactive organic sulphur compound in the oil, tempering the oil, adding said chemical agent thereto, adding inert gas thereto, removing formed reaction products therefrom, adding an oxidation inhibitor, adding a metal passivator.

22. An electrically insulating oil treatment apparatus, wherein the oil comprises at least one reactive organic sulphur compound, the apparatus comprising:
at least one vessel,
an amount of a chemical agent, wherein said chemical agent comprises an elementary halogen or a halogen compound, and
at least one vessel comprising an introducing element configured to introduce one or more amounts of the chemical agent into said electrically insulating oil.

23. The apparatus according to claim 22, wherein said elementary halogen comprises elementary iodine (I₂).

24. The apparatus according to claim 22, wherein said halogen compound comprises hydrogen iodide (HI).

25. The apparatus according to any of the claims claim 22, wherein the introducing element is configured to introduce the chemical agent is in a form of gas, liquid or solid.

26. The apparatus according to claim 22, wherein the introducing element is configured to introduce the chemical agent continuously.

27. The apparatus according to claim 22, further comprising:
at least one vessel configured to apply a reduced pressure atmosphere or vacuum on the oil.

28. The apparatus according to claim 22, further comprising:
at least one vessel configured to control temperature of content of the vessel.

29. The apparatus according to any of the claims claim 22, further comprising:
at least one vessel configured to introduce an inert gas into the oil.

30. The apparatus according to claim 22, further comprising:
at least one spectroscopic adsorption measurement device adapted to determine chemical agent concentration.

31. The apparatus according to claim 22, further comprising:
at least one vessel configured to add any of the group of metal passivator or oxidation inhibitor.

32. An electrically insulating oil treatment system, wherein the oil comprises at least one reactive organic sulphur compound, the system comprising:
an electrical apparatus containing said electrically insulating oil,
an oil treatment apparatus,
a transporter configured to move the oil from said electrical apparatus to said oil treatment apparatus, and
a removal configured to remove at least one reactive organic sulphur compound from the electrically insulating oil with a chemical agent comprising an elementary halogen or a halogen compound.

33. The system according to claim 32, wherein said elementary halogen comprises elementary iodide (I₂).

34. The system according to claim 32, characterised in that said halogen compound comprises hydrogen iodide (HI).

35. The system according to claim 32, wherein said oil treatment apparatus is adapted to remove volatile reaction products and excess chemical agent from the electrically insulating oil.

36. The system according to claim 32, wherein said transporter operates continuously.

37. The system according to claim 32, further comprising:
a return configured to feed back the treated electrically insulating oil back into said electrical apparatus.

38. The system according to claim 32, further comprising:
a mobile platform on which said oil treatment apparatus is mounted.

39. The system according to claim 38, further comprising:
an energy system,
a control system, and
storage for chemical agents and gases needed for oil treatment.

40. A computer program product, comprising:
a computer-readable medium; and
computer program instructions recorded on the computer readable medium and executable by a processor for carrying out a method of treating an electrically insulating oil, wherein the oil comprises at least one reactive organic sulphur compound, the method comprising adding to the oil a chemical agent causing a reaction with reactive organic sulphur compound, said chemical agent comprising an elementary halogen or a halogen compound.
